(19) United States
(12) Patent Application Publication
(10) Pub. No.: US 2006/0034069 A1
(43) Pub. Date: Feb. 16, 2006

(54) Frame for ceiling light fixture

(76) Inventor: Ae-Sook Seo, Nonsan-si (KR)

Correspondence Address: PARK LAW FIRM, 3255 WILSHIRE BLVD, SUITE 1110, LOS ANGELES, CA, 90010, US

(21) Appl. No.: 11/106,105

(22) Filed: Apr. 15, 2005

(30) Foreign Application Priority Data
Aug. 12, 2004 (KR) 20-2004-0023096

(51) Int. Cl. F21S 8/00

(52) U.S. Cl. 362/147

(57) ABSTRACT

A frame for a ceiling light fixture comprises a main body formed into a rectangular board, first and second side-panels formed by folding up both sides of the main body along the longitudinal direction thereof, and first and second hooking members formed on both sides of main body between the side-panels. The main body has a circular cavity for coupling the ceiling light fixture therein. Each side-panel has hooking apertures formed on both sides thereof and a plurality of hooks protruded outward between the hooking apertures. Each hooking member is bended to the same direction as the side-panel and has a hooking aperture therein. The hooking apertures of the side-panels and the hooking member are positioned on the same line. The supporting member for fixing the ceiling frame is hooked at three points, that is, at the both sides and center of the frame, thereby preventing the frame from wrapping.

### CLAIMING FOREIGN PRIORITY

The applicant claims and requests a foreign priority, through the Paris Convention for the Protection of Industry Property, based on patent application filed in the Republic of Korea (South Korea) with application number 20-2004-0023096, filed Aug. 12, 2004 by the applicant. (See the attached Declaration)

### BACKGROUND OF THE INVENTION

1. Field of the Invention

The present invention relates to an apparatus for mounting for a ceiling light fixture, more particularly to a frame for holding the ceiling light fixture in a ceiling.

2. Description of the Related Arts

In a ceiling of buildings, generally, a ceiling frame for mounting a light fixture is arranged away from the ceiling at an interval and ceiling boards are attached on the frame. The ceiling frame is made of wood or metal and the light fixture is equipped to insert into the ceiling boards or protrude outward.

In the case of inserting a light fixture into a ceiling board, an aperture is formed on the ceiling board to which an apparatus for mounting the light fixture is directly coupled. Then, the apparatus and the light fixture are held up by the supporting force of the ceiling board. Because the ceiling board is made of a thin square plate, it is undesirable to apply a heavy light fixture to the ceiling board.

As a method for preventing the ceiling board from wrapping, a board-type frame is arranged to couple the light fixture directly, hooking holes are formed on both sides of the board-type frame, and supporting members of bar shape are inserted into the hooking holes to couple with a ceiling frame. It has more advantages than coupling to the ceiling board directly but the board-type frame is also thin so that the wrapping problem is still remained.

### SUMMARY OF THE INVENTION

The present invention has been developed to solve the problems with above-described frame for a ceiling light fixture.

It is an object of the present invention to provide a frame for a ceiling light fixture, which is capable of preventing from wrapping even if the light fixture has a heavy weight.

In accomplishing the above and other objectives, a frame for a ceiling light fixture according to the present invention comprises a main body formed into a rectangular board, first and second side-panels formed by folding up both sides of the main body along the longitudinal direction thereof, and first and second hooking members formed on both sides of main body between the side-panels.

The main body has a circular cavity for coupling the ceiling light fixture therein. Each side-panel has hooking apertures formed on both sides thereof and a plurality of hooks protruded outward between the hooking apertures. Each hooking member is bended to the same direction as the side-panel and has a hooking aperture therein.

The hooking apertures of the side-panels and the hooking member are positioned on the same line, and may be formed into a close-loop shape or an open-loop shape so as to insert a supporting member into the frame.

### BRIEF DESCRIPTION OF THE DRAWINGS

FIG. 1 is a perspective view showing a frame for a ceiling light fixture according to an embodiment of the present invention.

FIG. 2 is a perspective view showing a frame for a ceiling light fixture according to another embodiment of the present invention.

FIG. 3 is a cross-sectional view showing a frame for a ceiling light fixture according to an embodiment of the present invention

### DETAILED DESCRIPTION OF THE EMBODIMENTS

Referring now to attaching the drawings, a frame for a ceiling light fixture according to an embodiment of the present invention will be described in detail. It is noted that like parts are designated by like reference numerals throughout the accompanying drawings.

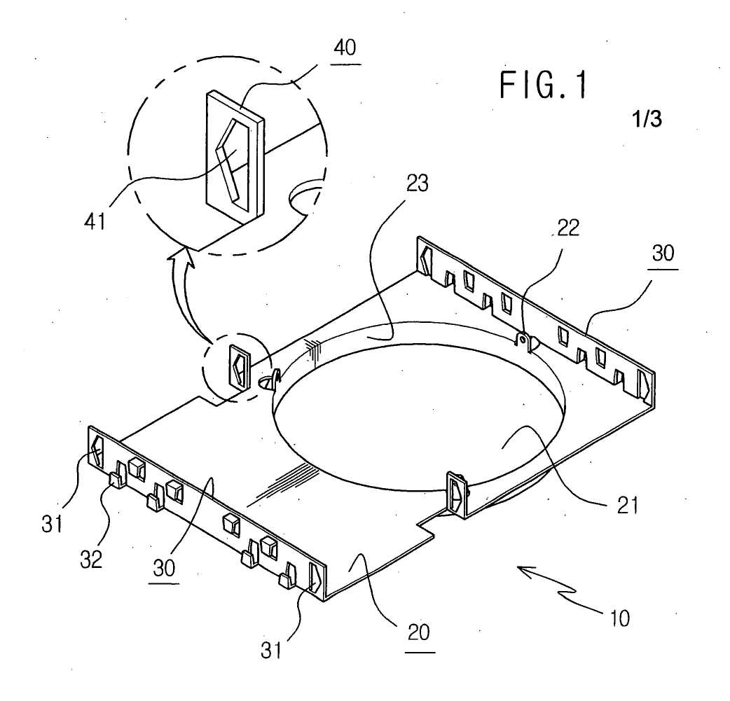

FIG. 1 depicts a frame 10 for a ceiling light fixture according to an embodiment of the present invention. As shown FIG. 1, the frame 10 for a ceiling light fixture comprises a main body 20 formed into a rectangular board and has a circular cavity 21 for coupling the ceiling light fixture therein, side-panels 30 formed by folding up both sides of the main body 20 along the longitudinal direction thereof, and hooking members 40 formed by bending up a portion of main body 20 between the side-panels.

The cavity 21 is deviated from the center of the main body 20 so that some equipment such as junction box 70 is set on the space occupied by the cavity 21.

Further, a reinforcing member 23 is formed down the main body 20 with extending from the outer periphery of the cavity 21 and one or more connecting members 22 having a through hole are protruded on the outer periphery. With punching a portion of the main body 20 close to the cavity 21 and bending the punched portion upward, the connecting member 22 is formed. With inserting a nail or screw into the through hole, a light fixture 60 is fixed on the connecting member 22 to couple with the cavity 21.

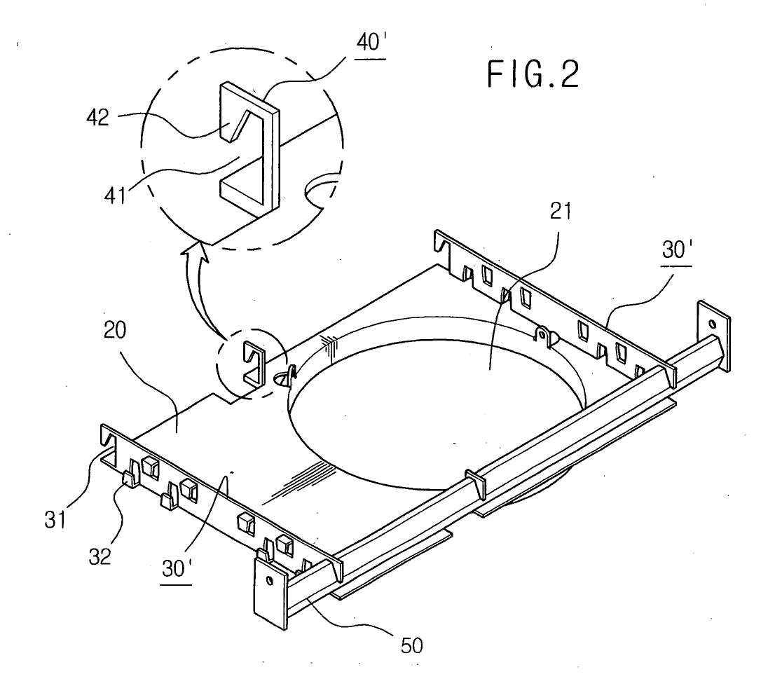

Each side-panel 30 has two hooking aperture 31 on both sides thereof and a plurality of hooks 32 are formed between the hooking apertures 31. A supporting member 50 (referred to FIG. 2) of bar shape for fixing the frame 10 is inserted into the hooking apertures 31. The form of the hooking apertures 31 can be varied in response to the cross section of the supporting member 50, such as a circle or a polygon.

In manufacturing the hooks 32, firstly similarly to the connecting member 22, the side-panels are punched in a predetermined shape, secondly the punched portions are bent to outer direction perpendicular to the side-panels, and thirdly the bent portions are bent up or down once more at regular distance from the side-panels 30. As shown FIG. 1, the hooks 32 are divided into upper side hooks and lower side hooks. The upper side hooks are bent down and the lower side hooks are bent up, so that the upper side and lower side hooks are opposed each other. A bar or board is inserted between the opposed hooks to support the frame.

Each hooking member 40 of the main body 20 has a hooking aperture 41 similarly to the aperture 31 of the side-panel 30, so that the supporting member 50 is inserted into the hooking aperture 41. Similarly, in manufacturing the hooking members 40, the main body is punched in a predetermined shape, and the punched portions are bent in the same direction as the side-panels.

The hooking aperture 41 of the hooking member 40 and the hooking apertures 31 of the side-panels are positioned on the same line, so that the supporting member 50 of bar shape is simultaneously inserted into three hooking apertures 31, 41.

FIG. 2 depicts a frame 10 for a ceiling light fixture according to another embodiment of the present invention.

Unlike the hooking aperture 40 formed into a close loop, the hooking member 40′ may be formed to have an opened portion as shown FIG. 2. With respect to the hooking member 40′ of above shape, the hooking aperture 31 of the side-panel 30′ is also formed to have the opened portion so that the supporting member 50 can be easily mounted or removed.

In the case of using the hooking member 40 of a close-loop shape as shown FIG. 1, the supporting member is mounted or removed in the longitudinal direction of the frame. On the other hand, in the case of using the hooking member 40′ of an open-loop shape as shown FIG. 2, the supporting member is mounted or removed by wrenching in the width direction of the frame. In the latter case, the frame can be stably supported with the protrusion parts 42 of the side-panels 30′ and the hooking member 40′.

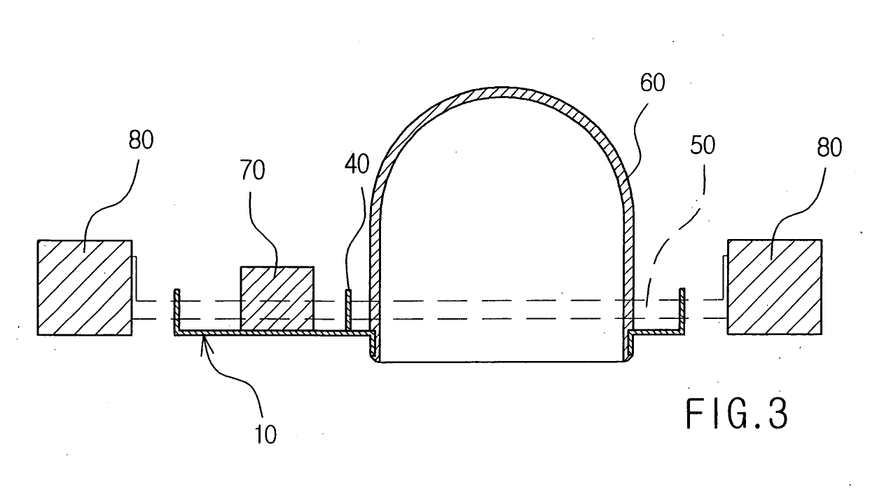

FIG. 3 is a cross-sectional view showing a frame for a ceiling light fixture according to an embodiment of the present invention.

As shown FIG. 3, the light fixture 60 is coupled to the cavity 21 formed on the main body 20 and a junction box 70 is mounted on the one side of the main body 20. Side-panels 30 are bent up and formed in a body on both sides of the frame 10, and hooking members 40 are is bent up and formed on the center of the frame.

Further, hooking apertures 31, 41 are formed on the side-panels 30 and the hooking members 40, respectively, so that a supporting member 50 of bar shape is inserted into the hooking apertures 31, 41. The supporting member 50 is coupled and fixed to a ceiling frame 80, which is arranged to mount ceiling boards.

As described above, the frame for a ceiling light fixture according to the present invention further comprises hooking members 40 formed on the center of the main body, so that the supporting member for fixing the ceiling frame is hooked at three points, that is, at the both sides and the center of the frame. Thus, it is possible to prevent the frame from wrapping due to the weight of the light fixture.

Although the present invention has been fully described by way of examples with reference to the accompanying drawings, it is to be noted that various changes and modifications will be apparent to those skilled in the art. Therefore, unless such changes and modifications depart from the scope of the present invention, they should be construed as being included therein.

What is claimed is:

1. A frame for a ceiling light fixture, which comprises:
a main body formed into a rectangular board and has a circular cavity for coupling the ceiling light fixture therein;
first and second side-panels formed by folding up both sides of the main body along the longitudinal direction thereof, and each having hooking apertures formed on both sides thereof and a plurality of hooks protruded outward between the hooking apertures; and
first and second hooking members formed on both sides of the main body between the side-panels, bended to the same direction as the side-panels, and has a hooking aperture therein;
wherein the hooking apertures of the side-panels and the hooking member are positioned on the same line.

2. A frame for a ceiling light fixture according to claim 1, wherein the hooking apertures of the side-panels and the hooking member are formed into a close-loop shape.

3. A frame for a ceiling light fixture according to claim 1, wherein the hooking apertures of the side-panels and the hooking member are formed into an open-loop shape.
